(19) United States
(12) Patent Application Publication
(10) Pub. No.: US 2009/0273594 A1
(43) Pub. Date: Nov. 5, 2009

(54) Apparatus and drive method for light emitting device array

(76) Inventors: Feng Li, Oxnard, CA (US); Gang Xu, Cupertino, CA (US); Bingwen Liang, Sunnyvale, CA (US); Chen-Jean Chou, New City, NY (US)

Correspondence Address: CHEN-JEAN CHOU, 21 RIDGEFIELD ROAD, NEW CITY, NY, 10956, US

(21) Appl. No.: 12/436,111

(22) Filed: May 5, 2009

Related U.S. Application Data
(60) Provisional application No. 61/050,260, filed on May 5, 2008.

(51) Int. Cl. G09G 3/14; G09G 5/00

(52) U.S. Cl. 345/214; 345/46

(57) ABSTRACT

A system and drive method for compensating intensity variation due to variation of operating cycles in a dynamically controlled system comprising a plurality of light emitting devices are provided in this invention.

### CROSS REFERENCE TO RELATED APPLICATIONS

The present application claims priority of U.S. Provisional Patent Application No. 61/050,260, filed on May 5, 2008.

### BACKGROUND OF THE INVENTION

1. Field of the Invention

The present invention relates to the drive method and system of multiple light emitting devices used in as illuminating source for an image display panel. The invention relates to a scheme that improves on the non-uniformity caused by the variation of time decay of light emitting device.

2. Description of the Prior Art

Light output of light emitting device, such as organic and inorganic light emitting diodes (LED), decreases over its operation life. The decrease of the light intensity follows a fairly predicable decay curve that may be characterized by a few parameters. In a system where multiple LEDs are structured as illuminating light source for a display panel, each LED decays according to its own operation time. Since the turn-on time for each LED depends on the image stream of a particular location and color, the LEDs are experiencing different decay cycle. It is unavoidable that the LEDs are not balanced between different colors and between different locations, after a certain period of operation. Such unbalance causes a color shift and various dim or bright spots on a display image.

The conventional method of improving the uniformity is to set a control window of the LED characteristic to select the LEDs of substantially similar performance and slow decay. This is a procedure that requires more LED testing, and limits the amount of usable LED. Furthermore, the variation in decay is caused by dynamic lighting that turns on LEDs for different durations. The initial screening can hardly offset the change caused by different operation time.

Another conventional method is to randomize the image in order to distribute the duty cycle (the duration during which a device is turned on) evenly among different LEDs. This is not effective as the randomization of images can be performed in between regular image display, but not on the actual image itself. Furthermore, this method tends to age the LEDs more than the actual operation time and therefore reduces the usable life of the LEDs.

The present invention provides a system and method to eliminate the need for smoothing the LED by over aging the device via randomization, and provide an effective method to keep LED output uniform across a large number of LED under dynamic lighting condition.

### SUMMARY OF THE INVENTION

The present invention uses a tracking method and a memory device to record the LED run time. The system further comprises a reference intensity levels for various times in the device operation life. Such information is also stored in a storage device. Each light emitting device is then reference to the different point of time decay according to its specific operating run time recorded via a tracking circuitry. The drive power is then adjusted to match each and every individual light emitting elements, and thus offsetting any non-uniformity arising from the time decay.

In the subsequent discussion, LED is used to represent various types of light emitting devices having similar characteristics of intensity decay over operation life.

### BRIEF DESCRIPTION OF THE DRAWING

FIG. 1 is a schematic drawing of the present invention.

FIG. 2 is a schematic drawing of the present invention.

### DETAILED DESCRIPTION OF THE INVENTION

The present invention is herein described in detail with reference to the drawings.

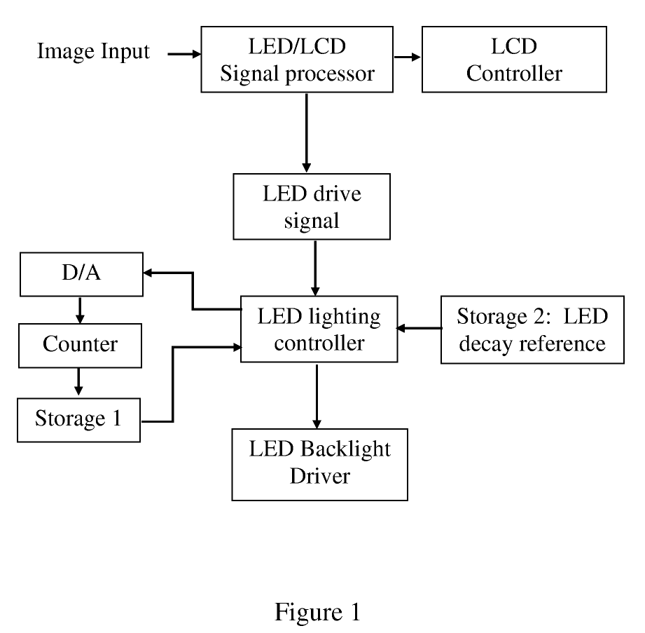

FIG. 1 provides a preferred embodiment of the schematics diagram of the present invention, wherein the LEDs are driven by the LED backlight driver, and the LED backlight driver receives driving signals from the LED lighting controller. The signals send to the LED driver comprises information corresponding to the light intensity of a particular LED to be driven by the driver.

Preferred embodiments of the control of LED backlight intensity include amplitude modulation (AM), pulse width (time duration) modulation (PWM), and pulse width modulation at variable amplitude. In the case of amplitude modulation, a current level is set for a particular LED to be driven to an intensity level corresponding to the set current level. The current level signal is sent to the driver from the controller and the driver delivers the corresponding current to the LED. In such case, the decay of the LED after being turned on at this current level is proportional to the amplitude of the current. Therefore, the information of the amplitude of the drive current is provided by the controller to a counter after first being converted via a D-to-A converter. In one preferred embodiment, each time a light emitting device is driven by a current I for time t, the weighed time, t×I, is counted by the counter for this light emitting device. In this embodiment, the weighed operating time is the time multiplied by the drive current. The is the scaled operating time. In another preferred embodiment, the weighed operating time is defined as the time multiplied by a factor proportional to the drive current. The counter accumulates the counts of weighed operating time for each LED and stores the counts in a storage device. The accumulated operating cycles for a light emitting device is the total of all such weighed operating times. Note that the weighed operating cycles is the weighed operating time, in an embodiment where time scale is used as the reference value. A different unit may be used to represent the accumulated weighed operating cycles.

Each time when the controller receives image intensity signal from the LCD/LED signal processor, the controller retrieves the recorded accumulated operating cycles of each LED stored in the storage, compare this value with the decay reference level stored in storage 2 and determines the reference intensity which represents an intensity level corresponds such a particular accumulated operating cycles. The drive current is then determined accordingly based on the reference level and the brightness level required by the image signal.

In one preferred embodiment, in determining the actual drive signal and current for a light emitting device, the controller first determines the intensity (Lt) of the light emitting device at a given accumulated operating cycles (t) using the given required intensity (L0) and the corresponding unadjusted drive current setting (I0). This drive current provides an actual intensity lower than the required setting because the light emitting device has aged over the time of operation. The controller raises the current inversely proportional to such decrease in intensity and thereby offset the decrease in intensity. One embodiment uses a scaling formula of It=I0×L0/Lt, where It is the actual drive current to be set at the time, L0 is the targeted intensity and is the time zero intensity of the light emitting device driven by the current I0, Lt is the reference intensity of the light emitting device driven by I0 at the time after accumulated operating cycles t, according to the reference information stored in the storage and interpolated if t is between two points.

In an embodiment of PWM, the intensity is proportional to the duration of keeping the LED turned on at a given current level. The LED backlight driver may receive a pulse width signal, or receive the same current signal as in the AM case and internally convert the current signal into pulse width. The current is linearly proportional to the duration. The aging effect of the LED is therefore proportional to the time or current level signal sent from the controller to the LED backlight driver. The circuit action of the counter, the method of extracting the decay point from storage 1, and referencing the level with storage 2 are similar to the case of AM. If the PWM scheme keeps the drive current constant, than the weighing of the cycle time may not be necessary.

A preferred embodiment for the controller to set the drive signal is to scale with the reference level. A preferred embodiment of the scaling procedure is to set the drive signal inversely proportional to the reference level corresponding to the operation counts of a LED. For example, when a image signal requires a particular light emitting device to deliver an intensity level of 124 out of a full brightness level at 256, and this LED has been operated for a certain time so that the reference level indicates that the full level output of this LED is 200, the scaling method sets this LED according to (128/200)×256=164 so that the when driven at level 164, this LED delivers a intensity of level 128 as required.

The dependence of light intensity of a light emitting device is often expressed in reference to the accumulated charge. The accumulated charge is the integral of the current versus time, which is equivalent to the total charge flowing through the light emitting device. The intensity decrease with the accumulated charge. In a preferred embodiment, the controller times each cycle time by the drive current, and the counter add the value to the accumulated charge and stored in the storage.

In Another preferred embodiment, both the drive current and the pulse width vary to achieve a given intensity. The accumulated operating duty in this embodiment is expressed in term of the sum of all the operating duties where each operating duty is the time during which a light emitting device is turned on by a drive current times the amplitude of the drive current.

A preferred embodiment for the first storage device is a DRAM holding the counts, and an EEPROM holding the decay reference level. The EEPROM is program at the end of the assembly with the decay date points measured on actual LED samples of similar product quality. The controller comprises a microprocessor to perform the data processing and input/output functions.

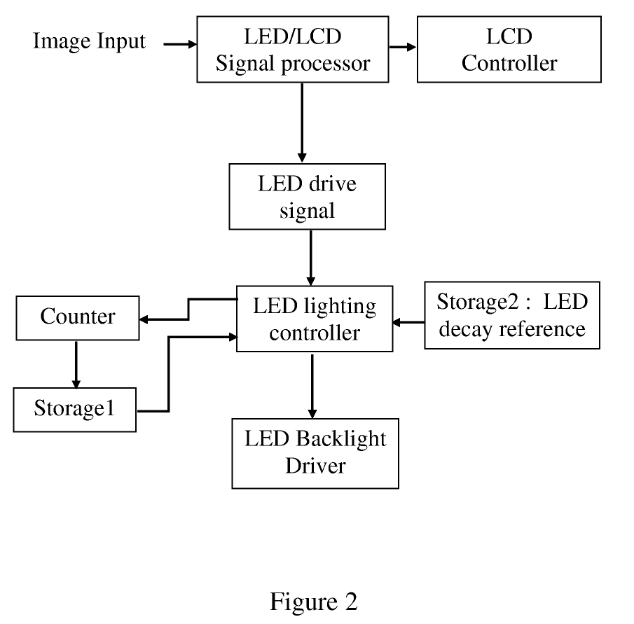

FIG. 2 provides another preferred embodiment, wherein the intensity drive signal is in a form of digital pulses where the combined total duration corresponds to the duration, and is proportional to the current. In this case the digital pulses may be directed registered into the counter, and the accumulated operation length is recorded in the storage device 1.

Various structures may be used to achieve the function of data counting, storage, and referencing. The application of the principles of the present invention however is not limited by the specific examples illustrate herein above. It is conceivable that the circuit blocks may be combined or separated for various design and cost considerations.

Although various embodiments utilizing the principles of the present invention have been shown and described in detail herein, those skilled in the art can readily devise many other variances, modifications, and extensions that still incorporate the principles disclosed in the present invention. The scope of the present invention embraces all such variances, and shall not be construed as limited by the number of elements, number of layers, or specific direction and angles.

What is claimed is:

1. A display apparatus comprising a plurality of light emitting devices constructed to illuminate an image display panel, a controller regulating said plurality of light emitting devices according to an input image information, further comprising:
A counter;
A first storage device;
A second storage device;
Wherein said counter counts the operation of each of said light emitting devices and provides the accumulated operation cycles of said light emitting devices;
wherein said first storage device records said accumulated operation cycles of said selected light emitting devices;
wherein said second storage device stores a plurality of reference levels, each said reference level corresponding to the light intensity for a light emitting device at a given drive current and after a given cycles of operation;
Wherein said controller sets an intensity level for a light emitting device according to the accumulated operation cycles and reference levels in said first and second storage devices by steps of:
(1) determine the drive condition for a light emitting device at its zero operation cycle, and
(2) increase the drive current to compensate the intensity decrease indicated by the reference level corresponding to the accumulated cycles of operation of said light emitting device;
wherein said operation cycles is proportional to the time and current of operating a light emitting device.

2. The display apparatus according to claim 1 wherein said accumulated operation cycles corresponds to the accumulated operating time; wherein said accumulated operating time corresponds to the total of time during which the light emitting device is driven at a given current.

3. The display according to claim 1 wherein said accumulated operation cycles correspond to the accumulated weighed operating time, wherein the weighed operating time corresponds to the time during which the light emitting device is turned on scaled with the drive current; wherein the time scaled with the drive current corresponds to the time multiplied by a factor proportional to the drive current.

4. A display apparatus comprising a plurality of light emitting devices constructed to illuminate an image display panel, a controller regulating said plurality of light emitting devices according to an input image information, further comprising:
A counter;
A storage device;
Wherein said counter records the accumulate operation duty of a selected group of said light emitting devices;
wherein said storage device records said accumulated operation duty of said selected light emitting devices;
wherein said storage device further stores a plurality of reference intensity levels corresponding to the time-dependent intensity of the light emitting device;
wherein said controller sets a given intensity level for a light emitting device by compensating the decrease of light output of said light emitting device according to the accumulated operation duty of said light emitting device and the corresponding decrease in light output of said light emitting device according to the time-dependent intensity; wherein said accumulated operating duty is proportional to the sum of all the operating duties where each operating duty is the time during which a light emitting device is turned on by a drive current times the amplitude of the drive current.

5. The display apparatus according to claim 4 wherein said accumulated operation duty corresponds to the accumulated charge; wherein said accumulated charge corresponds to the integration of current with time during which the light emitting device is driven at the said current.

6. The display apparatus according to claim 4 wherein said accumulated operation duty corresponds to the total charge, which is the total charge driven through a light emitting device.

7. The display apparatus according to claim 4 wherein said accumulated operating duty corresponds to the sum of all weighed operating times, said each weighed operating times is the time during which a light emitting device is turned on at a drive current times the amplitude of the drive current.

8. A display apparatus comprising a plurality of light emitting devices constructed to illuminate an image display panel, a controller regulating said plurality of light emitting devices according to an input image information, further comprising:
A counter;
A storage device;
Wherein said counter counts the accumulated operation duty of a selected group of said light emitting devices;
wherein said storage device records said accumulated operation duty of said selected light emitting devices;
wherein said storage device further stores a plurality of reference intensity levels corresponding to intensity of the light emitting device after a given accumulated operation duty;
Wherein said controller compensates light output of a given light emitting device by increase the drive current to said light emitting device so that the increase in light intensity offset the decrease of light output due to the decrease in light intensity according to the reference intensity.

9. The display apparatus according to claim 8 wherein said accumulated operation duty corresponds to the accumulated charge; wherein said accumulated charge corresponds to the integration of current over time during which the light emitting device is driven at the said current.
